(19) United States
(12) Patent Application Publication
(10) Pub. No.: US 2016/0072283 A1
(43) Pub. Date: Mar. 10, 2016

(54) DEVICE CAPABLE OF CHARACTERIZING SUPPLY DRAWN AND ADAPTING DEVICE PERFORMANCE ACCORDINGLY

(71) Applicant: Creative Technology Ltd, Singapore (SG)

(72) Inventors: Aik Hee Daniel GOH, Singapore (SG); Ee Hui SIEK, Singapore (SG); Susimin SUPRAPMO, Singapore (SG)

(73) Assignee: CREATIVE TECHNOLOGY LTD, Singapore (SG)

(21) Appl. No.: 14/479,008

(22) Filed: Sep. 5, 2014

(51) Int. Cl. H02J 1/14

(52) U.S. Cl. CPC H02J 1/14

(57) ABSTRACT

A device is provided. The device can be configured to characterize supply drawn from a supply source and calibrate device performance accordingly by operating in one of a plurality of operating modes. The plurality of operating modes can include a conservation mode, a normal mode and an optimum performance mode. The device can include a characterizing part and an adaption part.

### FIELD OF INVENTION

The present disclosure generally relates to a device which can characterize supply drawn from a source supply and adapt device performance accordingly.

### BACKGROUND

In general, when a consumer purchases an electronic gadget, it comes packaged with a charger. The electronic gadget can be a device with a proprietary battery for powering up the device. The charger can be used to one or both of re-charge the battery and powering up the device. The charger can otherwise be referred to as a power adaptor (or simply “adaptor”).

It may be desirable for the consumer to own more than one adaptor for the same device (e.g., one adaptor to be placed at home and one adaptor to be placed in office). Hence the consumer may wish to purchase one or more adaptors in addition to the original one that came with the device.

In this regard, the consumer may turn to aftermarket sources for such a purchase. Aftermarket sources may manufacture adaptors (i.e., aftermarket adaptors) that are generally suitable for some commonly used devices. However, since different devices may have different supply requirements, care must be taken to ensure that a suitable aftermarket adaptor is paired with a particular device. Failure to do so may result in the device not being able to power up or overheating.

Since the aftermarket adaptor may be not manufactured in accordance with the supply requirement specification of the consumer's device, the onus is on the consumer to ensure that the aftermarket adaptor bought is suitable for a particular device.

To provide a solution to ensure that a consumer does not purchase an unsuitable aftermarket adaptor, some aftermarket sources have made available adaptors that may be capable of providing varying supplies (i.e., a multi-supply aftermarket adaptor). This may be a convenient solution in that the same aftermarket adaptor can be used for different devices with each having different supply requirements. Specifically, a consumer may be allowed to make an adjustment/selection (i.e., at the adaptor) in accordance with the supply requirements of the device to which the multi-supply aftermarket adaptor is paired. However, the onus is still on the consumer to ensure that the correct adjustment/selection is made.

It is therefore desirable to provide a solution to address at least one of the foregoing problems. Specifically, it is at least desirable to provide a solution for pairing an adaptor and a device in a user friendly manner.

### SUMMARY OF THE INVENTION

In accordance with an aspect of the disclosure, a device is provided. The device can be configured to characterize supply drawn from a supply source and calibrate device performance accordingly by operating in one of a plurality of operating modes. The plurality of operating modes can include a conservation mode, a normal mode and an optimum performance mode.

The device can include a characterizing part and an adaption part.

The characterizing part can be configured to receive the supply and characterize the supply drawn. The characterizing part can be further configured to generate and communicate control signals based on the characterized supply.

The adaption part can be configured to receive the control signals and adapt signal processing based on the control signals. Signal processing can be adapted based on one of the conservation mode, the normal mode and the optimum performance mode.

When in the conservation mode, signal processing is being adapted such that device performance is poorest compared to device performance during normal mode and device performance during optimum performance mode.

When in the normal mode, signal processing is being adapted such that device performance is better compared to device performance in conservation mode but not better than device performance during optimum performance mode.

When in the optimum performance mode, signal processing is being adapted such that device performance is best compared to device performance during conservation mode and device performance during normal mode.

In one embodiment, the supply source can, for example, be an adaptor capable of providing a regulated supply.

In one embodiment, the characterizing part can include a detector portion and a controller portion.

The detector portion can be configured to receive the regulated supply and determine supply characteristics of the regulated supply. Additionally, the detector portion can be configured to provide a feedback indicative of the supply characteristics of the regulated supply to the controller portion. The controller portion can be configured to control the detector portion in the manner in which supply characteristics of the regulated supply are determined. Additionally, the controller portion can be further configured to generate and communicate control signals based on the feedback received from the detector portion.

In one embodiment, the device can further include a signal source part which can be configured to generate source signals. Additionally, the adaption part can include a processing portion and an output portion.

The processing portion can be configured to receive and process the source signals to produce processed source signals. The output portion can be configured to receive and process the processed source signals to produce output signals. Signal processing can be based on one or both of the processing portion and the output portion. Additionally, signal processing can be adapted based on control signals being communicated to one or both of the processing portion and the output portion.

In one embodiment, the adaption part can further include a convertor portion. Signal processing can be based further on the convertor portion. Additionally, signal processing can be adapted based on control signals being further communicated to the convertor portion.

### BRIEF DESCRIPTION OF THE DRAWINGS

Embodiments of the disclosure are described hereinafter with reference to the following drawings, in which:

FIG. 1 shows a system which can include a power source portion, an adapter portion, a device and an output module, in accordance with an embodiment of the disclosure;

FIG. 2 shows the system of FIG. 1 in greater detail where the device can include a detector portion, in accordance with an embodiment of the disclosure;

FIG. 3 shows a possible arrangement of the detector portion of FIG. 2, in accordance with an embodiment of the disclosure; and

FIG. 4 shows a flow diagram for a method in association with the system of FIG. 1, in accordance with an embodiment of the disclosure.

### DETAILED DESCRIPTION

Representative embodiments of the disclosure, for addressing one or more of the foregoing problems, are described.

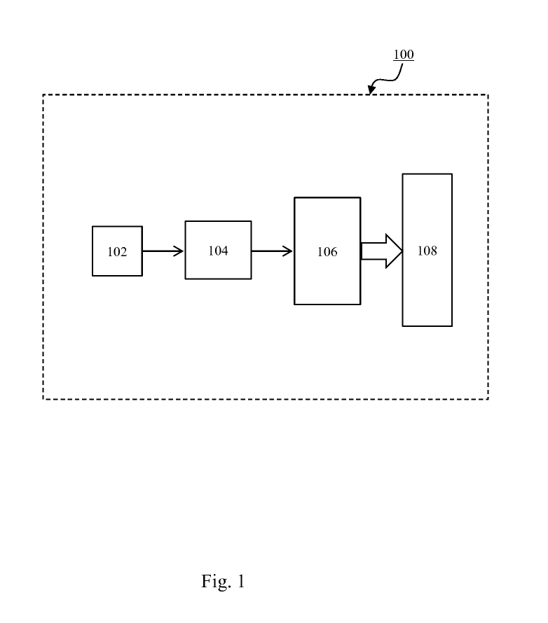

Specifically, the present disclosure relates to a device (labeled as “106” in FIG. 1) which is capable of characterizing supply that can be drawn and calibrate/adapt performance of the device accordingly.

More specifically, the device can be configured to detect/determine the amount of supply that can be drawn from a supply source (as will be referred to as “adapter portion 104” in FIG. 1) and adapt performance of the device accordingly. In this regard, the device can be capable of characterizing supply by detecting amount of supply which is supplied or which can be supplied.

Amount of supply that can be drawn from/supplied by the supply source can, for example, be based on the maximum allowable supply that can be drawn/supplied.

Maximum allowable supply that can be drawn/supplied can typically be limited by factors such as the amount the supply source itself is capable of supplying and/or the amount the device is capable of receiving before failure/malfunction occurs. Other factors can include, for example, manual limitation (e.g., where the supply source corresponds to the aforementioned multi-supply aftermarket adaptor which output limit can be adjusted/selected by a consumer).

Supply drawn/supplied can be associated with one or more supply parameters such as one or both of supply voltage (measurable in Volts) and supply current (measurable in Amperes). In this regard, the aforementioned characterizing of supply by detecting amount of supply can be associated with determining one or both of amount of supply voltage and amount of supply current supplied or which can be supplied.

Additionally, supply current and/or supply voltage drawn by the device from the supply source can typically be one of the following:
1) Minimum value (i.e., minimum supply current and/or supply voltage)
2) Typical value (i.e., typical supply current and/or supply voltage)
3) Maximum value (i.e., maximum supply current and/or supply voltage)

Minimum value refers to the minimum supply that needs to be supplied to the device by the supply source to enable basic functional performance of the device (e.g., turn on). If the supply source is not able to provide at least the minimum supply, the device may not be able to turn on.

Typical value refers to the typical supply that needs to be supplied to the device to enable normal operation (i.e., all operational functions) of the device. If the supply source provides the normal supply to the device should be able to perform all the functions it is capable of performing. However, if typical supply is provided to the device, the device may only be capable of normal/typical performance and may not be capable of optimum performance.

Maximum value refers to the maximum supply that can be supplied to the device and yet allow the device to function without risk of malfunction/failure. Appreciably, if the supply source provides a supply which is beyond the maximum value (i.e., over supply), the device may malfunction. However, if maximum supply can be supplied to the device, the device may be capable of optimum performance.

Moreover, performance of the device can, for example, be in relation to output audio performance of the device. Output audio performance of the device can, for example, be in relation to audibly perceivable sound quality as will be discussed later in further detail.

In this regard, the device can be operated in one of a plurality of operations modes depending on the supply drawn/supplied. Specifically, the device can be operated in one of a plurality of operations modes depending on supply current and/or supply voltage which can be drawn by the device from the supply source. The plurality of operation modes can include conservation mode, normal mode and optimum performance mode.

Therefore, the device can characterize supply that can be drawn (e.g., by determining one or both of amount of supply voltage and amount of supply current supplied or which can be supplied) and adapt device performance accordingly by operating in one of the following modes:
1) Conservation mode
2) normal mode
3) optimum performance mode

In this regard, each of the conservation mode, normal mode and the optimum performance mode can be associated with a supply requirement. The supply requirement can be based on the aforementioned minimum value, typical value or maximum value.

In one example, when the device detects/determines that the maximum allowable supply current (e.g., limited by the maximum amount of current that the supply source is capable of supplying) that can be drawn from the supply source corresponds to minimum value, the device can be configured to operate in conservation mode where components within the device operate based on minimum supply current.

In another example, when the device detects that the maximum allowable supply current (e.g., limited by the maximum amount of current that the supply source is capable of supplying) that can be drawn from the supply source corresponds to typical value, the device can be configured to operate in normal mode where components within the device operate based on typical supply current.

In yet another example, when the device detects that the maximum allowable supply current that can be drawn (e.g., either limited by the maximum amount of current the supply source is capable of supplying or limited by the amount of current that the device is capable of receiving) corresponds to maximum value, the device can be configured to operate in optimum performance mode where components within the device operate based on maximum supply current.

Although the above examples are in the context of supply current drawn, it is appreciable that the above examples can analogously be in the context of supply voltage drawn. It is further appreciable that the above examples can analogously be in the context of a combination of supply current drawn and supply voltage drawn.

Appreciably, performance (e.g., output audio performance) of the device during conservation mode can be considered to be poorest compared to during normal mode and optimum performance mode. Moreover, performance (e.g., output audio performance) of the device during optimum performance mode can be considered to be better compared to during normal mode.

Hence, in terms of performance, best performance can be attained during optimum performance mode followed by normal mode followed by conservation mode.

As mentioned earlier, the device can be capable of characterizing supply drawn (e.g., supply current) and calibrate/adapt performance of the device accordingly. In one embodiment, this can be done automatically. In another embodiment, the device can be capable of characterizing supply and calibrate/adapt performance of the device accordingly on a real-time basis. In yet another embodiment, the device can be capable of characterizing supply and, at the same time, automatically calibrate/adapt performance of the device accordingly on a real-time basis

In one example, when the device characterizes that the maximum allowable supply current drawn corresponds to minimum value, the device can automatically calibrate/adapt performance of the device accordingly by operating in conservation mode.

In another example, when the device characterizes that the maximum allowable supply current drawn corresponds to typical value, the device can automatically calibrate/adapt performance of the device accordingly by operating in normal mode.

In yet another example, when the device characterizes that the maximum allowable supply current drawn corresponds to maximum value, the device can automatically calibrate/adapt performance of the device accordingly by operating in optimum performance mode.

In yet a further example, the maximum allowable supply current drawn from the supply source may initially correspond to maximum value. However, maximum allowable supply current drawn may subsequently be reduced to minimum value due to, for example, overheating (e.g., of the device and/or of the supply source). In this regard, the device may initially characterize the maximum allowable supply current drawn to correspond to maximum value and the device calibrates/adapts performance of the device accordingly by operating in optimum performance mode. Subsequently (in the event of, for example, overheating and the maximum allowable supply current drawn is reduced to minimum value), the device may characterize the maximum allowable supply current drawn to correspond to minimum value and may, consequently, calibrate/adapt performance of the device accordingly by operating in conservation mode. Therefore, it is appreciable that the device can be capable of characterizing supply and calibrate/adapt performance of the device accordingly on a real-time basis.

Although the above examples are in the context of supply current drawn, it is appreciable that the above examples can analogously be in the context of supply voltage drawn. It is further appreciable that the above examples can analogously be in the context of a combination of supply current drawn and supply voltage drawn.

The foregoing will be discussed in further detail with reference to FIG. 1 to FIG. 4 hereinafter.

Referring to FIG. 1, a system 100 is shown, in accordance with an embodiment of the disclosure. The system can include a power source portion 102, an adapter portion 104, a device 106 and an output module 108.

The power source portion 102 can be coupled to the adapter portion 104. The adapter portion 104 can be coupled to the device 106. The device 106 can be coupled to the output module 108.

The power source portion 102 can be a source for supplying power (i.e., indirectly) to the device 106 so as to power the device 106 for operation. However, the device 106 may require a regulated supply for proper operation. In this regard, the adapter portion 104 can be configured to receive supply from the power source portion 102 and regulate the received supply so as to produce a regulated supply (i.e., direct) to power the device 106.

In this regard, the adapter portion 104 can be further configured to communicate the regulated supply to the device 106. Specifically, the adapter portion 104 can be configured to feed the device 106 with the regulated supply so as to power the device 106.

When the device 106 is properly powered, the device 106 can be configured to produce output signals which can be communicated to the output module 108. The output module 108 can be configured to receive and process the output signals. The output module 108 can, for example, be configured to receive and process the output signals so that they can be one or both of audibly and visually perceived.

The output signals can, for example, be audio based output signals. In this regard, the output module 108 can, for example, include one or more speaker drivers to output the audio based output signals so that the audio based output signals can be audibly perceived.

Earlier mentioned, the present disclosure relates to a device (i.e., device 106) which is capable of characterizing supply drawn from a supply source (i.e., the adapter portion 104) and calibrate/adapt performance of the device accordingly.

Specifically, output signals produced by the device 106 can be based on regulated supply fed to the device 106 by the adapter portion 104. More specifically quality (which can subsequently be one or both of visually and audibly perceived via the output module 108) of the output signals can be dependent on the regulated supply fed to the device 106 by the adapter portion 104.

In general, regulated supply from the adapter portion 104 can be associated with one or more supply characteristics corresponding to the aforementioned one or more supply parameters. Examples of supply characteristics can include voltage supply characteristics (i.e., supply voltage) and current supply characteristics (i.e., supply current). Voltage supply characteristics can relate to voltage value (i.e., amount of voltage measured in volts) supplied to the device 106. Current supply characteristics can relate to current value (i.e., amount of current measured in amperes) supplied to the device 106.

The device 106 can be configured to determine supply characteristic(s) of the regulated supply from the adapter portion 104. For example, the device 106 can be configured to determine what is the amount of current the adapter portion 104 is capable of supplying. Therefore, the device 106 can characterize supply drawn from the adapter portion 104 by, for example, determining what is the amount of current the adapter portion 104 is capable of supplying.

Although the example of determining amount of current the adapter portion 104 is capable of supplying is used, It is appreciable that amount of voltage the adapter portion 104 is capable of supplying can also be determined. It is further appreciable that it is also possible to determine a combination of amount of current and amount of voltage the adapter portion 104 is capable of supplying.

For the purpose of brevity, the remaining discussion will be based largely on the example of amount of current (the adapter portion 104 is capable of supplying) determined. Specifically, for the purpose of brevity, the remaining discussion will be based largely on the example of the device 106 being configured to characterize supply drawn from the adapter portion 104 by determining what is the amount of current the adapter portion 104 is capable of supplying.

Based on, for example, the determined amount of current the adapter portion 104 is capable of supplying, the device 106 can be configured to calibrate/adapt device performance.

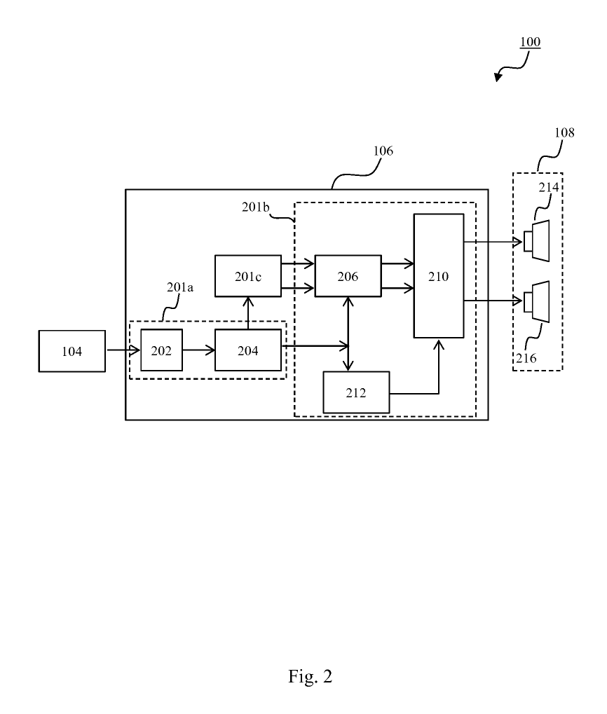

Specifically, based on the determined amount of current, the device 106 can be configured to adapt internal processing of signals to produce corresponding output signals. This will be discussed later in further detail with reference to FIG. 2.

More specifically, based on the determined amount of current the adapter portion 104 is capable of supplying to the device 106, the device 106 can be configured to operate in one of the aforementioned conservation mode, normal mode and optimum performance mode.

Yet more specifically, the device 106 can include one or more components in relation to the aforementioned internal processing. The component(s) can be associated with one or more power supply requirements. Specifically, power requirement(s) associated with the component(s) can be based on:
1) minimum supply requirement
2) typical supply requirement
3) maximum supply limit

Minimum supply requirement can be based on the minimum power supply that needs to be supplied to the component(s) in order for the component(s) to at least turn on/power up. Minimum power supply can be in relation to one or both of voltage and current supplied to the component(s).

Typical supply requirement can be based on the typical power supply requirement(s) of the component(s). Typical power supply can be in relation to one or both of voltage and current supplied to the component(s). Maximum supply limit can be based on the maximum power supply that the component(s) is/are able to accept before failure/malfunction of the component(s) can occur. Maximum supply can be relation to one or both of voltage and current supplied to the component(s).

Based on the power requirement(s) associated with the component(s) in the device 106, it is possible to determine supply requirement associated with each of the aforementioned conservation mode, normal mode and optimum performance mode as will be discussed in further detail with reference to FIG. 2 hereinafter.

Referring to FIG. 2, the system 100 is shown in greater detail, in accordance with an embodiment of the disclosure. In particular, the device 106 and the output module 108 are shown in greater detail, in accordance with an embodiment of the disclosure.

As shown, the device 106 can include a characterizing part 201a and an adaption part 201b. The device 106 can further include a signal source part 201c. The output module 108 can, for example, include a plurality of speaker drivers. In one embodiment, the output module 108 can include a first speaker driver 214 and a second speaker driver 216.

The characterizing part 201a can be configured to receive the supply from the adaptor portion 104 and characterize the supply drawn (i.e., from the adaptor portion 104). The characterizing part 201a can be further configured to generate and communicate control signals based on the characterized supply.

The adaption part 201b can be configured to receive the control signals and adapt signal processing based on the control signals. Signal processing can be adapted based on one of the aforementioned conservation mode, the normal mode and the optimum performance mode.

The signal source part 201c can be configured to generate source signals which can be audio based source signals. The generated source signals can, for example, include a right audio signal and a left audio signal. The generated source signals can be communicated from the signal source part 201c to the adaption part 201b as will be discussed later in further detail.

The characterizing part 201a and the adaption part 201b will now be discussed in further detail.

The characterizing part 201a can include a detector portion 202 and a controller portion 204. The adaption part 201b can include a processing portion 206 and an output portion 210. The adaption part 201b can, as an option, further include a converter portion 212.

Earlier mentioned, the device 106 can include one or more components in relation to the aforementioned internal processing. The one or more components can correspond to the detector portion 202, the controller portion 204, the processing portion 206, the output portion 210 and/or the convertor portion 212. Preferably, the one or more components can correspond to any of the processing portion 206, the output portion 210 and the convertor portion 212, or any combination thereof.

The adaptor portion 104 can be coupled to one or both of the characterizing part 201a and the adaption part 201b. As an option, the adaptor portion 104 can be further coupled to the signal source part 201c.

More specifically, the adapter portion 104 can be coupled to any one of the detector portion 202, the controller portion 204, the processing portion 206, the output portion 210 and the signal source part 201c, or any combination thereof (not shown). The adapter portion 104 can optionally be coupled (not shown) to the converter portion 212.

The detector portion 202 can be coupled to the controller portion 204. The controller portion 204 can be coupled to one or both of the processing portion 206 and the signal source part 201c. The controller portion 204 can optionally be coupled to the converter portion 212. The processing portion 206 can be coupled to the output portion 210. Additionally, the signal source part 201c can be coupled to the processing portion 206. The converter portion 212 can, optionally, be coupled to the output portion 210.

The output portion 210 can be coupled to the first and second speaker drivers 214/216.

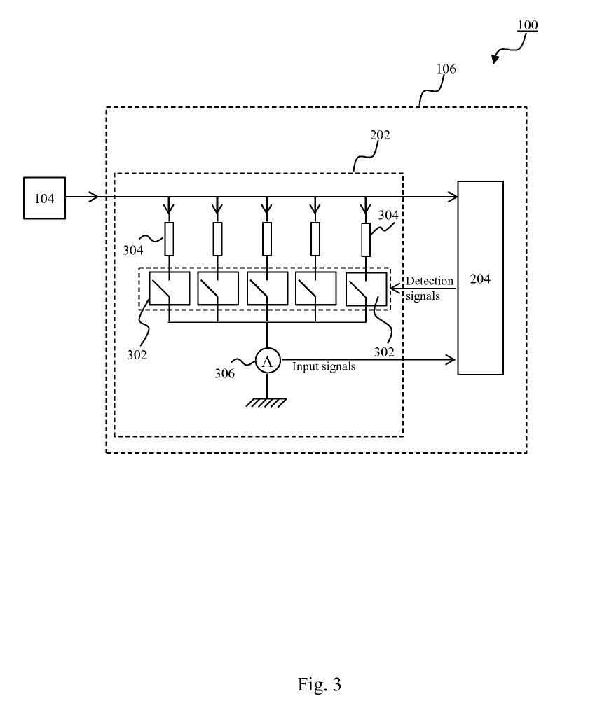

The detector portion 202 can be configured to receive the regulated supply from the adapter portion 104 and determine the supply characteristic(s) of the regulated supply. Based on the determined supply characteristics, feedback can be provided from the detector portion 202. For example, feedback in the form of input signals can be communicated from the detector portion 202. Based on the example of maximum allowable current which can be supplied, the supply characteristic determined by the detector portion 202 can be the amount of current which can be supplied by the adapter portion 104. In this regard, the detector portion can include a current measurement circuit (which functions similarly to an ammeter for measuring current). Input signals (i.e., feedback) indicative of the amount of current supplied by the adapter portion 104 can be communicated from the detector portion 202 to, for example, the controller portion 204. The detector portion 202 will be discussed later in further detail with reference to FIG. 3.

The controller portion 204 can, for example, correspond to a microcontroller or a microprocessor. The controller portion 204 can be configured to generate and communicate detection signals to the detector portion 202 to control the detection portion 202 as will be discussed later in further detail with reference to FIG. 3. The controller portion 204 can be further configured to receive input signals and process the input signals to produce control signals.

The control signals can be communicated to the adaption part 201b. In one embodiment, the control signals can be communicated to the processing portion 206. In another embodiment, the control signals can be communicated to the converter portion 212. In yet another embodiment, the control signals can be communicated to the processing portion 206 and the converter portion 212. This will be discussed later in further detail.

Earlier mentioned, the generated source signals can be communicated from the signal source part 201c to the adaption part 201b. More specifically, the source signals generated by the signal source part 201c can be communicated to the processing portion 206.

The processing portion 206 can, for example, correspond to an audio processor configured to perform audio processing of the source signals to produce processed source signals. Preferably, the processing portion 206 can be configured to perform audio processing of the source signals communicated from the signal source part 201c.

Examples of audio processing include equalization (EQ) processing and gain processing. Other examples are also useful. EQ processing can relate to adjusting frequency response of the source signals. Frequency response can be in relation to the low frequency range components (i.e., bass), mid-range frequency components and/or high frequency range (i.e., treble) components of the source signals. Gain processing can relate to amplitude adjustment of the source signals. Amplitude adjustment can be in terms of attenuation or amplification. Therefore, gain processing can be in relation to adjusting loudness (i.e., boosting/attenuating the source signals).

Earlier mentioned, the adaption part 201b can be configured to receive the control signals and adapt signal processing based on the control signals. Signal processing can be adapted based, for example, on one or both of EQ processing and gain processing. In this regard, based on the control signals communicated from the controller portion 204, the processing portion 206 can be configured to process source signals communicated from the signal source part 201c by one or both of EQ processing and gain processing to produce processed source signals. The processed source signals can be communicated from the processing portion 206 to the output portion 210 for further processing. Aside adapting signal processing based on, for example, EQ processing and/or gain processing, other examples are also useful. One such example can be in relation to the converter portion 212 in regard to conversion of regulated supply as will be discussed later in further detail.

The output portion 210 can, for example, correspond to a power amplifier. In this regard, the output portion 210 can be configured to receive and further process the processed source signals by, for example, one of amplifying and attenuating them to produce output signals. Specifically, the output portion 210 can be configured to, for example, either provide gain to amplitudes of the processed source signals or attenuate amplitudes of the processed source signals. More specifically, the output portion 210 can be configured to, for example, either increase loudness (i.e., boost the processed source signals) or decrease loudness (i.e., attenuate the processed source signals). Of course, if neither increase nor decrease in loudness is desired, the output portion 210 can simply be configured to maintain loudness (i.e., unity gain—in which case, the output signals can simply correspond to the processed source signals).

The converter portion 212 can, for example, correspond to a DC (i.e., Direct Current) to DC type voltage converter. For example, the converter portion 212 can be configured to convert DC voltage supplied to it from the adapter portion 104 to another DC voltage. Therefore, the convertor portion 212 can be configured to receive a DC supply voltage (e.g., supplied by the adapter portion 104) and convert the received DC supply voltage to produce a converted supply output. The conversion can, for example, be a downward based conversion (i.e., lower than the supplied DC voltage from the adapter portion 104) or an upward based conversion (i.e., higher than the supplied DC voltage from the adapter portion 104). In one example, in respect of downward based conversion, where the DC voltage supplied to the converter portion 212 is 5V, the converter portion 212 can be configured to perform downward based conversion so as to output a voltage which is lower than 5V (e.g., 2.5V). In another example, in respect of upward based conversion, where DC voltage supplied to the convertor portion 212 is 5V, the convertor portion 212 can be configured to perform upward based conversion so as to output a voltage which is higher than 5V (e.g., 10V).

In one embodiment, as an option, the converted DC supply voltage can be used as a supply for, for example, the output portion 210. Therefore, for the output portion 210, instead of drawing supply from the adapter portion 104 (i.e., the regulated supply) directly, supply can be drawn from the converter portion 212 (i.e., converted supply output).

Appreciably, since the generated source signals can, for example, include a right audio signal and a left audio signal, the processed source signals can correspondingly include a right processed audio signal and a left processed audio signal. Additionally, the output signals can correspondingly include a right output signal (i.e., based on the right processed audio signal) and a left output signal (i.e., based on the left processed audio signal).

The output signals can be communicated from the output portion 210 to the output module 108 for output. For example, the output signals can include a right output signal and a left output signal. The right output signal can be communicated to the first speaker driver 214 and the left output signal can be communicated to the second speaker driver 216. In this regard, the right output signal and the left output signal can be output such that they can be audibly perceived via the first speaker driver 214 and the second speaker driver 216 respectively.

Earlier mentioned, based on the determined amount of current that can be drawn from the adapter portion 104, the device 106 can be configured to adapt internal processing of signals to produce corresponding output signals. More specifically, based on the determined amount of current that the adapter portion 104 is capable of supplying to the device 106, the device 106 can be configured to operate in one of the aforementioned conservation mode, normal mode and optimum performance mode. In this context, internal processing of signals can refer to how the device 106 processes signals internally (i.e., within the device 106).

Preferably, this can be done by configuring the detector portion 202 and the controller portion 204 to determine the amount of current supplied by the adapter portion 104, and further configuring the controller portion 204 to produce control signals based on the determined amount of current. As mentioned earlier, the control signals can be communicated to one or both of the processing portion 206 and the converter portion 212.

Specifically, in one embodiment, the control signals can be communicated to the processing portion 206. In another embodiment, the control signals can be communicated to the converter portion 212. In yet another embodiment, the control signals can be communicated to the processing portion 206 and the converter portion 212.

When the control signals are communicated from the controller portion 204 to the processing portion 206, the processing portion 206 can be configured to audio process the generated source signals by, for example, one or both of EQ processing and gain processing. In this regard, signal processing (i.e., internal processing of signals) can be adapted based, for example, on one or both of EQ processing and gain processing.

When the control signals are communicated from the controller portion 204 to the converter portion 212, the convertor portion 212 can be configured to convert the regulated supply (e.g., DC voltage) either upwards or downwards. In this regard, signal processing (i.e., internal processing of signals) can be adapted based on, for example, conversion (either upwards or downwards) of regulated supply.

When the control signals are communicated from the controller portion 204 to both the processing portion 206 and the converter portion 212, the processing portion 206 can be configured to audio process the generated source signals by, for example, one or both of EQ processing and gain processing. At the same time, the convertor portion 212 can be configured to convert the regulated supply (e.g., DC voltage) either upwards or downwards. In this regard, signal processing (i.e., internal processing of signals) can be adapted based, for example, on a combination of:
1) conversion (either upwards or downwards) of regulated supply; and
2) EQ processing and/or gain processing.

To put the foregoing in perspective, the foregoing will be discussed further in respect of an exemplary scenario hereinafter.

In one exemplary scenario, in respect of the device 106, the controller portion 204 can be a microprocessor integrated chip (IC) having a manufacturer specification where the supply voltage to the microprocessor IC is 5 Volts (v)+/−10% (i.e., minimum required voltage supply of 4.5V, typical voltage supply of 5V and maximum allowed voltage supply of 5.5V). The output portion 210 can be a power amplifier having a power rating of 30 Watts (W).

Generally, power requirement(s) associated with the component(s) can be based on, for example, power rating as specified by the manufacturer(s) of the component(s). Additionally, power rating which can be measured in Watts (W) can be associated with voltage which can be measured in Volts (V) and/or current which can be measured in Amperes (A).

Additionally, in the exemplary scenario, to determine whether the device 106 operates in conservation mode, normal mode or optimum performance mode, it is contemplated that the following should be determined:
1) What is the maximum allowable current the adapter portion 104 is capable of supplying?
2) What is the amount of current required for each of the in conservation mode, normal mode or optimum performance mode?

In one embodiment, to determine the maximum allowable current the adapter portion 104 is capable of supplying, a combination of the detector portion 202 and the controller portion 204 will be required.

Specifically, the detector portion 202 can be configured to draw current at controlled intervals from the adapter portion 104 and measure the amount of current being drawn each time. At the same time, the controller portion 204 can be configured to monitor the fluctuation in voltage supplied from the adaptor portion 104.

More specifically, the detector portion 202 can be configured to draw a different amount of current at each of the aforementioned controlled intervals. Preferably, increasing current can be drawn by the detector portion 202 for each successive controlled interval. For each time (i.e., at each interval) an amount of current is drawn by the detector portion 202, the detector portion 202 can be configured to measure the amount of current drawn and the controller portion 204 can be configured to monitor the fluctuation in voltage supplied from the adaptor portion 104 to the controller portion 204. Moreover, control signals can be communicated from the controller portion 204 to the detector portion 202 for controlling the detector portion 202 in a manner so that the detector portion 202 can draw current at controlled intervals.

For example, the adaptor portion 104 can be supplying a 5V voltage (i.e., typical voltage supply) supply to the controller portion 204. The detector portion 202 can be configured to draw current from the adaptor portion 104 at five controlled intervals (i.e., a first controlled interval to a fifth controlled interval) at an increasing amount of 100 mA for each successive interval. Therefore, at the first controlled interval, the detector portion 202 can be configured to draw 100 mA of current from the adaptor portion 104. At the second controlled interval, the detector portion 202 can be configured to draw 200 mA of current from the adaptor portion 104. Subsequently, at the third to fifth controlled intervals, the detector portion 202 can be configured to draw, respectively, 300 mA, 400 mA and 500 mA of current from the adaptor portion 104. Moreover, at each controlled interval, the controller portion 204 monitors the supplied voltage from the adaptor portion and it can be expected that voltage supplied from the adaptor portion 104 will drop as current drawn increases (e.g., based generally on: Power (W)=Voltage (V)×Current (A)). If the supplied voltage drops to the minimum required voltage supply, it is indicative that the current drawn at that point in time can be considered to be the maximum allowable current which the adaptor portion 104 is capable of supplying.

In a more specific example, at the abovementioned first to fifth controlled intervals where the detector portion 202 draws, correspondingly, 100 mA to 500 mA of current from the adapter portion 104, the controller portion 204 measures/detects that the voltage supplied by the adaptor portion 104 at each instant to be 5V, 4.9V, 4.8V, 4.7V and 4.5V respectively (i.e., during the first controlled interval, the voltage supplied is measured/detected to be 5V; during the second controlled interval, the voltage supplied is measured/detected to be 4.9V; during the third controlled interval, the voltage supplied is measured/detected to be 4.8V; during the fourth controlled interval, the voltage supplied is measured/detected to be 4.7V; during the first controlled interval, the voltage supplied is measured/detected to be 4.5V). Appreciably, 4.5V is identified to be the minimum required voltage (e.g., based manufacturer specification). Hence, the current measured/detected (i.e., 500 mA) when the voltage supplied is measured/detected to be about/equal to the minimum required voltage (4.5V) can be considered/indicative of the maximum allowable current (e.g., 500 mA) the adaptor portion 104 is capable of supplying.

Alternatively, based on the above example, where the detector portion 202 is configured to draw, 100 mA to 500 mA of current from the adapter portion 104 at corresponding first to fifth controlled intervals, the drawn current measured at the detector portion 202 is less than the amount supposed to be drawn and the supplied voltage does not fall below the minimum required voltage, maximum allowable current the adaptor portion 104 is capable of supplying can be determined.

For example, at the fifth controlled interval (when the drawn current amount is supposed to be 500 mA), the measured current drawn at that instant (i.e., during the fifth controlled interval) is 450 mA and the detected/measured supply voltage (e.g., 4.8V) is still more than the minimum required voltage (e.g., 4.5V), it can be indicative that 450 mA is the maximum allowable current the adaptor portion 104 is capable of supplying.

Based on the characterized maximum allowable current drawn from the adaptor portion 104, the device 106 can be configured to operate in one of the following modes:
1) conservation mode
2) normal mode
3) optimum performance mode

Appreciably, the amount of current required for each of the in conservation mode, normal mode or optimum performance mode needs to be determined.

Determination can, for example, be based on one of the components of the device 106. More specifically, determination can, for example, be based on the power amplifier (i.e., output portion 210).

In one example, based on the power rating (e.g., 30 W) of the power amplifier and voltage supplied to the power amplifier, it may be possible to characterize the minimum current requirement of the power amplifier, the typical current requirement of the power amplifier and the maximum current acceptable to the power amplifier. Further considerations can, for example, be parameters such as loss due to heat dissipation and/or efficiency.

In another example, manufacturer specification of the power amplifier may characterize the minimum current requirement of the power amplifier, the typical current requirement of the power amplifier and the maximum current acceptable by the power amplifier.

Therefore, if the characterized maximum allowable current drawn from the adaptor portion 104 is about/equal to the characterized minimum current requirement of the power amplifier, the device 106 can be configured to operate in the conservation mode.

Furthermore, if the characterized maximum allowable current drawn from the adaptor portion 104 is about/equal to the characterized typical current requirement of the power amplifier, the device 106 can be configured to operate in the normal mode.

Moreover, if the characterized maximum allowable current drawn from the adaptor portion 104 is about/equal to the characterized the maximum current acceptable by the power amplifier, the device 106 can be configured to operate in the optimum performance mode.

Therefore, based on the combination of determined:
1) maximum allowable current the adapter portion 104 is capable of supplying; and
2) amount of current required for each of the in conservation mode, normal mode or optimum performance mode,

the controller portion 204 can be configured to generate and communicate control signals to one or both of the processing portion 206 and the converter portion 212.

Earlier mentioned performance of the device 106 can, for example, be in relation to output audio performance of the device. Output audio performance of the device can, for example, be in relation to audibly perceivable sound quality. This will now be discussed in further detail with reference to the device 106 being operable in one of the aforementioned conservation mode, normal mode and optimum performance mode.

In one embodiment, output audio performance can be varied by audio processing (which can include, for example, equalization (EQ) processing and/or gain processing) using the processing portion 206. In another embodiment, output audio performance can be varied by conversion of regulated supply (e.g., DC variance) using the converter portion 212 as will be discussed later in further detail. In yet another embodiment, output audio performance can be varied by both audio processing using the processing portion 206 and conversion of regulated supply using the converter portion 212 as will also be discussed later in further detail.

Variance of output audio performance by audio processing using the processing portion 206 will be discussed hereinafter.

Gain processing can, as mentioned earlier, relate to amplitude adjustment of the source signals (i.e., adjusting loudness of the source signals by either amplification or attenuation). In this regard, gain processing can be via changing of audio volume. For example, the processing portion 206 can be configured to change (e.g., by either boosting or attenuating) the amplitude of a source signal to produce processed source signals. Hence the processing portion 206 can be capable of functioning as an electronic volume control which can be controlled by, for example, a user using a rotary knob (not shown). Volume control can be associated with a plurality of steps (e.g., effectively increasing/decreasing volume by 1 decibel (dB) per step). Using the example of the rotary knob, audio volume can be increased by a number of steps if a user rotates/turns the rotary knob in a clockwise direction. Conversely, if the user rotates/turns the rotary knob in an anticlockwise direction, audio volume can be decreased by a number of steps.

The plurality of steps can be associated with a plurality of control ranges. The plurality of control ranges can include a minimum range, a typical range and a maximum range. In an example, volume control can be associated with a maximum of 12 steps. In this regard, the maximum range can be associated with a range of 0 (no sound/mute) to 12 steps (maximum volume). The typical range can be associated with a range of 0 (no sound/mute) to 10 steps (i.e., close to maximum volume, but unable to attain maximum volume). The minimum range can be associated with a range of 0 (no sound/mute) to 5 steps (i.e., very limited gain increase is possible).

EQ processing can, as mentioned earlier, relate to adjusting frequency response of the source signals. Frequency response can be in relation to the low frequency range components (i.e., bass), mid-range frequency components (i.e., mid-range) and/or high frequency range (i.e., treble) components of the source signals. Adjustment of frequency response can, for example, relate to either attenuating or boosting one or more portions of the frequency response (i.e., bass, mid-range and/or treble)

When the device 106 operates in conservation mode, control signals can be communicated from the controller portion 204 to the processing portion 206 so that control range associated with the processing portion 206 can be based on minimum range in accordance with an embodiment of the disclosure. Additionally, when the device 106 operates in conservation mode control signals can be communicated from the controller portion 204 to the processing portion 206 so that EQ processing can be such that at least one portion of the frequency response (e.g., bass) can be attenuated, in accordance with another embodiment of the disclosure. In accordance with yet another embodiment of the disclosure, control signals can be communicated from the controller portion 204 to the processing portion 206 so that control range associated with the processing portion 206 can be based on minimum range and at least one portion of the frequency response (e.g., bass) can be attenuated, when the device 106 operates in conservation mode. The rationale is that in conservation mode, only minimum supply current can be supplied to the device 106. Hence there may not be enough supply current to the component(s) (e.g., the output portion 210) within the device 106 to enable proper operation. In this regard, by limiting control range (i.e., based on minimum range) and/or attenuating at least one portion of the frequency response, less supply current will be required. Appreciably, sound quality under such condition(s) can be considered to be poor.

When the device 106 operates in optimum performance mode, control signals can be communicated from the controller portion 204 to the processing portion 206 so that control range associated with the processing portion 206 can be based on maximum range in accordance with an embodiment of the disclosure. Additionally, when the device 106 operates in optimum performance mode, control signals can be communicated from the controller portion 204 to the processing portion 206 so that EQ processing can be such that at least one portion of the frequency response (e.g., bass) can be boosted, in accordance with another embodiment of the disclosure. In accordance with yet another embodiment of the disclosure, control signals can be communicated from the controller portion 204 to the processing portion 206 so that control range associated with the processing portion 206 can be based on maximum range and at least one portion of the frequency response (e.g., bass) can be boosted, when the device 106 operates in optimum performance mode. The rationale is that in optimum performance mode, maximum supply current can be supplied to the device 106. Hence the component(s) (e.g., the output portion 210) within the device 106 can operate at maximum potential. For example, during optimum performance mode, loudness of the source signals can be amplified to the fullest possible extent without risk of distorting the output signals. Appreciably, sound quality under such condition(s) can be considered to be optimum.

When the device 106 operates in normal performance mode, control signals can be communicated from the controller portion 204 to the processing portion 206 so that control range associated with the processing portion 206 can be based on typical range in accordance with an embodiment of the disclosure. Additionally, when the device 106 operates in normal performance mode, control signals can be communicated from the controller portion 204 to the processing portion 206 so that EQ processing can be such that one or more portions of the frequency response can be boosted or attenuated, in accordance with another embodiment of the disclosure. In accordance with yet another embodiment of the disclosure, control signals can be communicated from the controller portion 204 to the processing portion 206 so that control range associated with the processing portion 206 can be based on typical range and one or more portions of the frequency response can be boosted or attenuated, when the device 106 operates in normal performance mode. Appreciably, sound quality when the device 106 is operating in normal performance mode can be considered to be better compared to sound quality when the device 106 is operating in conservation mode, but not better than sound quality when the device 106 is operating in optimum performance mode.

Therefore, sound quality when the device 106 operates in conservation mode can be considered to be poorest compared with when the device 106 operates in normal performance mode/optimum performance mode. Sound quality when the device 106 operates in optimum operation mode can be considered to be best compared with when the device 106 operates in conservation mode/normal mode. Hence, in terms of sound quality, optimum operation mode can be considered best, followed by normal mode, followed by conservation mode.

Earlier mentioned, output audio performance can be varied by DC variance using the converter portion 212. This will be discussed in further detail hereinafter.

The converter portion 212 can, as discussed earlier, be configured to convert DC voltage supplied to it from the adapter portion 104 to another DC voltage (i.e., converted DC supply voltage). The converted DC supply voltage can be used as a supply for the output portion 210. Therefore, for the output portion 210, instead of drawing supply from the adapter portion 104 (i.e., the regulated power supply) directly, supply can be drawn from the converter portion 212 (i.e., converted supply output).

When it is determined that the device 106 can be operated in optimum performance mode, control signals can be communicated from the controller portion 204 to the converter portion 212 so that conversion of the supplied DC voltage from the adapter portion 104 can be based on upward conversion. For example, where DC voltage supplied to the convertor portion 212 is 5V, the convertor portion 212 can be configured to perform upward based conversion so as to output a voltage which is higher than 5V (e.g., 10V). In doing so, it is appreciable that the output voltage swing of the output portion 210 can be increased. In general, output voltage swing can be defined as the maximum positive and/or minimum peak output voltage (about a DC bias) that can be obtained without output waveform distortion. Appreciably, based on the above example, with upward conversion to 10V, the swing range can be 0V to 10V with 5V being the DC bias as compared with a swing range of 0V to 5V with 2.5V being the DC bias without the upward conversion. Hence with increased output voltage swing, it is appreciable that the output signals can be further amplified without risk of distortion.

When it is determined that the device 106 is to be operated in conservation mode, control signals can be communicated from the controller portion 204 to the converter portion 212 so that conversion of the supplied DC voltage from the adapter portion 104 can be based on downward conversion. For example, where DC voltage supplied to the convertor portion 212 is 5V, the convertor portion 212 can be configured to perform upward based conversion so as to output a voltage which is lower than 5V (e.g., 3V). In doing so, it is appreciable that the output voltage swing of the output portion 210 can be decreased. In general, output voltage swing can be defined as the maximum positive and/or minimum peak output voltage (about a DC bias) that can be obtained without output waveform distortion. Appreciably, based on the above example, with downward conversion to 3V, the swing range can be 0V to 3V with 1.5V being the DC bias as compared with a swing range of 0V to 5V with 2.5V being the DC bias without the upward conversion. Hence with decreased output voltage swing, it is appreciable that the current consumption by the output portion 210 can be reduced.

When it is determined that the device 106 is to be operated in normal mode, control signals can be communicated from the controller portion 204 to the converter portion 212 so that no conversion occurs (i.e., neither upward conversion nor downward conversion). For example, where DC voltage supplied to the convertor portion 212 is 5V, the convertor portion 212 can continue to supply a 5V voltage supply to the output portion 210.

Earlier mentioned, in yet another embodiment, output audio performance can be varied by both audio processing using the processing portion 206 and DC variance using the converter portion 212. In this regard, the foregoing discussion relating to audio processing using the processing portion 206 and DC variance using the convertor portion 212 applies analogously.

Referring to FIG. 3, the detector portion 202 is shown in greater detail in accordance with an embodiment of the disclosure.

As shown, the detector portion 202 can include a shunt arrangement which includes a plurality of branches in a parallel arrangement. Each of the branches can include a switch 302 and a resistor 304 arranged in series.

Earlier mentioned, the controller portion 204 can be configured to generate and communicate detection signals to the detector portion 202 to control the detection portion 202.

Specifically, detection signals can be communicated from the controller portion 204 to either open or close one or more of the switches 302 so as to vary the amount of current the detector portion 202 is capable of drawing from the adapter portion 202 (for example, per earlier discussion regarding how the detector portion 202 can be configured to draw current at controlled intervals from the adapter portion 104).

The detector portion 202 can further include a measurement portion 306 for measuring the amount of current being drawn each time. Input signals indicative of the measured current can be communicated from the measurement portion 306 to the controller portion 204.

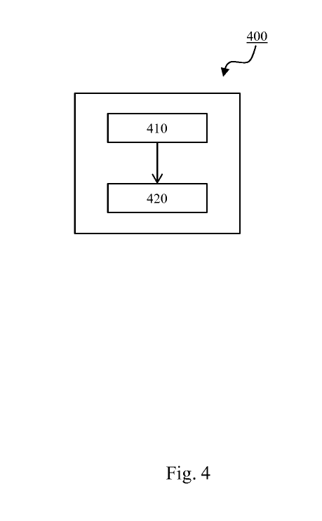

Referring to FIG. 4, a flow diagram for a method 400 in association with the system 100 is shown, in accordance with an embodiment of the disclosure.

The method 400 can include a characterization step 410 and a device performance adaption step 420.

In the characterization step 410, one or more supply characteristics of the supply drawn from the adaptor portion 104 can be characterized per earlier discussion in FIG. 2. In this regard, relevant portions of the earlier discussion with reference to FIG. 2 analogously apply.

In the device performance adaption step 420, operation mode the device 106 can be determined. Operation mode can be one of the aforementioned conservation mode, normal operation and optimum performance mode. Operation mode of the device 106 can be determined based on the characterized supply characteristic(s) of the supply drawn from the adaptor portion 104 per earlier discussion in FIG. 2. In this regard, relevant portions of the earlier discussion with reference to FIG. 2 analogously apply.

Earlier mentioned, the device 106 can be capable of characterizing supply and calibrate/adapt performance of the device accordingly on a real-time basis and/or automatically. Therefore, it is appreciable that one or both of the characterization step 410 and the device performance adaptation step 420 can be performed on a real-time basis and/or automatically.

In regard to the system 100 and method 400, it is appreciable the aforementioned issue with having to pair a suitable adaptor (i.e., supply source) with a device can be addressed. Specifically, even if the adaptor is only able to provide the minimum required supply to the device, the device is still capable of operating (i.e., conservation mode). If the adaptor provides more supply than the typical requirement, the device can be capable of making use of the excess supply and boost device performance (i.e., optimum operation mode). However, if the adaptor provides only the typical supply requirement, the device can operate normally per manufacturer's specification for typical/normal performance (i.e., normal mode). Therefore, it is appreciable that the system 100 and method 400 facilitate convenient pairing of an adaptor with a device without the user of the device having to ascertain the supply characteristic(s) of the adaptor and the supply requirement of the device. Therefore, pairing of an adaptor and a device can be done in a user friendly manner.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

For example, aside EQ processing and/or gain processing with respect to audio processing by the processing portion 206, other examples of audio processing can include muting a portion of the generated source signals (e.g., either the right audio signal or the left audio signal).

1. A device which is configurable to characterize supply drawn from a supply source and calibrate device performance accordingly by operating in one of a plurality of operating modes which include a conservation mode, a normal mode and an optimum performance mode, the device comprising:
a characterizing part configurable to receive the supply and characterize the supply drawn, the characterizing part further configurable generate and communicate control signals based on the characterized supply; and
an adaption part configurable to receive the control signals and adapt signal processing based on the control signals, signal processing being adapted based on one of the conservation mode, the normal mode and the optimum performance mode,
wherein in the conservation mode, signal processing is being adapted such that device performance is poorest compared to device performance during normal mode and device performance during optimum performance mode,
wherein in the normal mode, signal processing is being adapted such that device performance is better compared to device performance in conservation mode but not better than device performance during optimum performance mode, and
wherein in the optimum performance mode, signal processing is being adapted such that device performance is best compared to device performance during conservation mode and device performance during normal mode.

2. The device as in claim 1, the supply source being an adaptor capable of providing a regulated supply and the characterizing part comprising:
a detector portion configurable to receive the regulated supply and determine supply characteristics of the regulated supply; and
a controller portion configurable to control the detector portion in the manner in which supply characteristics of the regulated supply are determined,
wherein the detector portion provides a feedback indicative of the supply characteristics of the regulated supply to the controller portion, and
wherein the controller portion is further configurable to generate and communicate control signals based on the feedback received from the detector portion.

3. The device as in claim 2, the device further comprising a signal source part configurable to generate source signals, and the adaption part comprising:
a processing portion configurable to receive and process the source signals to produce processed source signals; and
an output portion configurable to receive and process the processed source signals to produce output signals,
wherein signal processing is based on at least one of the processing portion and the output portion, and
wherein signal processing is adaptable based on control signals being communicated to at least one of the processing portion and the output portion.

4. The device as in claim 3, the adaption part further comprising a convertor portion,
wherein signal processing is based further on the convertor portion, and
wherein signal processing is adaptable based on control signals being further communicated to the convertor portion.
